(19) United States
(12) Patent Application Publication
(10) Pub. No.: US 2024/0176636 A1
(43) Pub. Date: May 30, 2024

(54) DEADLOCK AND HANG AVOIDANCE IN A LARGE DISTRIBUTED COMPUTER SYSTEM

(71) Applicant: International Business Machines Corporation, Armonk, NY (US)

(72) Inventors: Matthias KLEIN, Poughkeepsie, NY (US); Deanna Postles Dunn BERGER, Hyde Park, NY (US); Robert J. SONNELITTER, III, Bedford Hills, NY (US); Kenneth Douglas KLAPPROTH, Austin, TX (US); Timothy BRONSON, Round Rock, TX (US); Gregory William ALEXANDER, Pflugerville, TX (US); Ashraf ELSHARIF, Austin, TX (US)

(21) Appl. No.: 18/060,424

(22) Filed: Nov. 30, 2022

(51) Int. Cl. G06F 9/455

(52) U.S. Cl. CPC G06F 9/45558; G06F 2009/4557; G06F 2009/45583

(57) ABSTRACT

A network of hang avoidance controllers and components which provide layer or scope based hang avoidance mechanisms in a distributed computing system is described. The detection of hang avoidance conditions and activation of the hang avoidance mechanisms are implemented on various limited scopes in the computing system, which prevent unnecessary system wide interruptions to avoid potential hangs in the system.

### BACKGROUND

The present disclosure relates to providing hang avoidance in large scale computing systems, and more specifically to providing efficient hang avoidance without disrupting an entire computing system via layered hang avoidance mechanisms with varying scopes.

Current hang avoid mechanisms for large scale computing systems rely on system wide avoidance processes where hang avoidance is activated on a wide scale across many resources and requestors in a system. As large scale computing systems are developing towards more distributed architectures, improvement in providing targeted and limited hang avoidance remains a challenge.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The method also includes detecting, at a first time and at a fast hang avoidance (FHA) controller, that an FHA condition for a resource request exceeds a first threshold for FHA activation on at least one FHA component in a first system scope of a plurality of system scopes, determining a first FHA request status for the resource request and the FHA controller based on activation settings for the FHA controller, a requestor type for the resource request, and the first system scope, and activating, based on the first FHA request status, FHA mechanisms on the at least one FHA component within the first system scope. Other embodiments of this aspect include corresponding computer systems, apparatus, and computer programs recorded on one or more computer storage devices, each configured to perform the actions of the methods.

One general aspect includes a system. The system also includes processor and a memory containing a program which when executed by the processor performs an operation which may include: detecting, at a first time and at a fast hang avoidance (FHA) controller, an FHA condition for a resource request exceeds a first threshold for FHA activation on at least one FHA component in a first system scope of a plurality of system scopes, determining a first FHA request status for the resource request and the FHA controller based on activation settings for the FHA controller, a requestor type for the resource request, and the first system scope, and activating, based on the first FHA request status, FHA mechanisms on the at least one FHA component within the first system scope.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The method also includes receiving, at a fast hang avoidance (FHA) controller for a first level in a system, a resource request for a resource, detecting, at the FHA controller, a current FHA activation status, determining active FHA mechanisms for the resource request based on a request type for the resource request, FHA settings at the FHA controller, and the current FHA activation status, and processing the resource request according to the active FHA mechanisms. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates a computing system, according to one embodiment.

FIG. 2 illustrates a computing subsystem, according to one embodiment.

FIG. 3 illustrates a computing subsystem, according to one embodiment.

FIG. 4 illustrates activation scopes for hang avoidance mechanisms, according to one embodiment.

FIG. 5 illustrates a state machine for activating scope based hang avoidance, according to embodiments described herein.

FIG. 6 illustrates a method for activating scope based hang avoidance, according to embodiments described herein.

FIG. 7 illustrates a state machine for implementing scope based hang avoidance, according to embodiments described herein.

FIG. 8 illustrates a method for implementing scope based hang avoidance, according to embodiments described herein.

FIG. 9 illustrates a block diagram of a system, according to one embodiment.

### DETAILED DESCRIPTION

Large scale computer systems contain many different and independent requestors and resources. The requestors generate requests for the resources and the varying computer processing and communication components in the computer system provide access to the resources. These requestors may include processors, input/output (I/O) devices, accelerators, and other specialized controllers, among many other requestors with varying types and functions. The resources may include interface access, cache line access, memory access, utilization of special purpose hardware (HW) engines, etc. In many examples, the resources are “shared” among the independent requestors, where requestors may request access to a same resource. As computing systems develop, both the number and type of these requestors and corresponding resources, including shared resources, continually increases.

Many computing systems, including large scale computing systems, attempt to provide fair access to all resources across all possible requestors in order to provide efficient processing across the entire system. However, the complexity of these computing systems and the large number internal or external interactions between requestors and resources often results in unfair resource allocation. For example, implementation details for the requestor/resources or the timing of access patterns may cause unbalanced or unfair resource allocation and access. In some examples, certain requestors may be effectively locked out of access to resources and resource starve to the point that the locked out requestor, a portion of the system, or the entire computing system may experience responsiveness issues. For example, a slowdown in processing, a livelock, a deadlock, or complete hangs which cause system checkstops may result from a requestor being perpetually locked out from a resource.

Some example computing systems include various mechanisms which attempt to anticipate the potential for hangs and livelock issues and provide measures to transparently resolve these in a timely manner and with minimal performance impact. For example, System wide Fast Hang Quiesce (FHQ) is a mechanism which detects when a requestor has reached a system wide threshold indicating a potential hang and the FHQ intervenes with a system wide intervention strategy to stop all requestors from issuing new requests. However, FHQ and other similar mechanisms are not able to effectively provide hang avoidance in many distributed computing systems, such as Symmetric multiprocessing (SMP) systems, among others. For example, a highly distributed computing system design may lead to a very high frequency of system wide FHQ events, leading to notable performance degradation. As large scale computing systems are developing towards more distributed functions, improvement in providing targeted scope level hang avoidances is needed.

The embodiments describe herein provide a method and system infrastructure for a network of hang avoidance controllers and components which provide layer or scope based hang avoidance mechanisms activated and implemented on various limited scopes in the computing system.

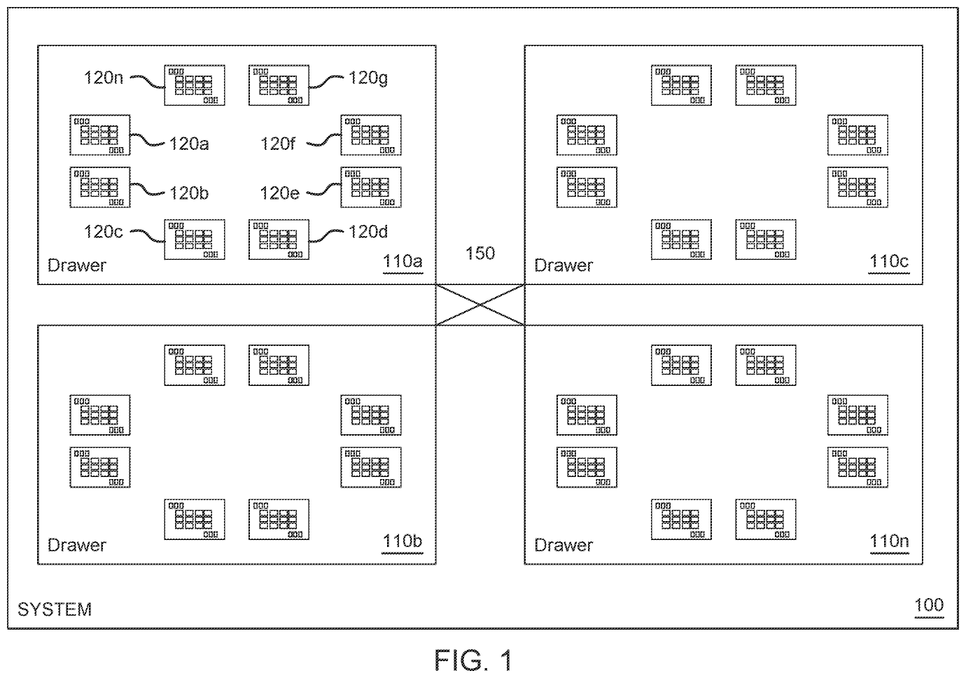

FIG. 1 illustrates a computing system, according to one embodiment. The system 100 is a large scale computing system that includes distributed systems (e.g., an SMP system, etc.). In some examples, the system 100 includes thousands of independent requestors distributed across various system components and subsystems. Each of these independent requestor generates resource requests and competes for access to system resources in the system 100. As described herein, the system 100 also includes Fast Hang Avoidance (FHA) mechanisms to provide for efficient access to system resources while preventing system hangs and deadlocks as described herein.

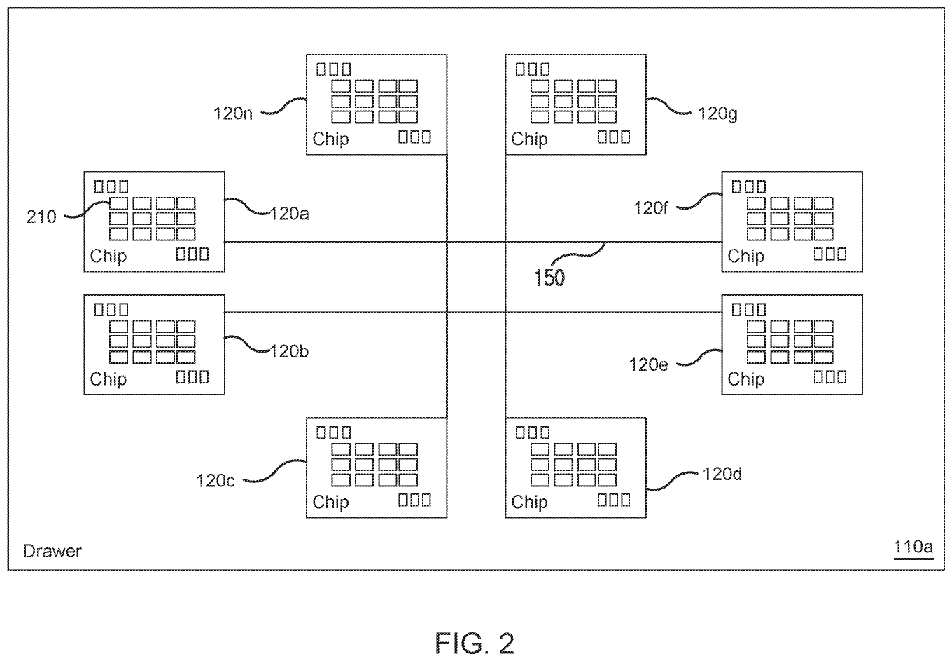

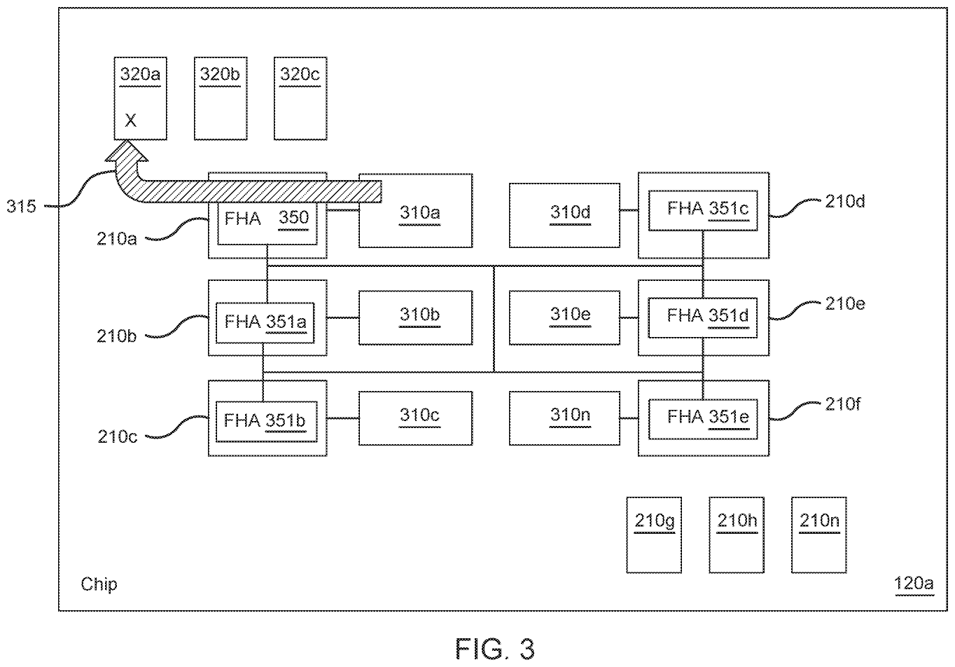

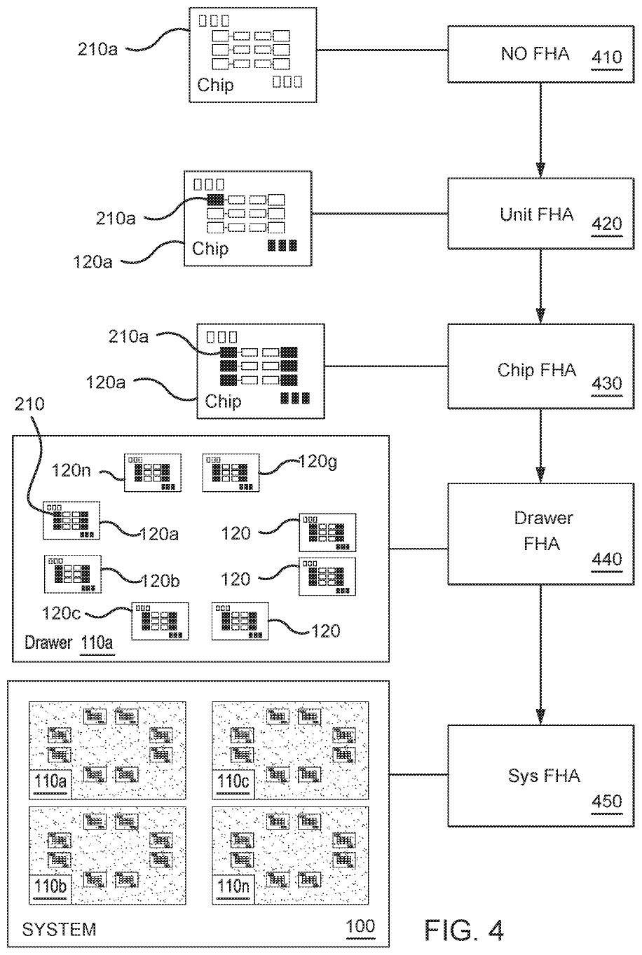

For example, FIGS. 2 and 3 illustrate computing subsystems, according to embodiments. FIG. 2 includes a zoomed view of a drawer 110a, shown in FIG. 1, and FIG. 3 illustrates a zoomed view of a chip 120a shown in FIGS. 1 and 2. As shown in FIG. 2, the drawer 110a includes chips 120a-120n, where each of the chips 120a-120n includes resources and requestors such as components 210. The components 210 are shown in more detail in FIG. 3, where the chip 120a includes components 210a-210n, requestors 310a-310n, and resources 320a-320c.

The components 210a and 210b-210n include FHA controllers such as controllers 350 and 351a-351n. While FHA controllers are only shown on the components 210a-210n in FIG. 3, each resource, requestor, or other appropriate computing component in the system 100 may also include an FHA controller. While described herein in relation to components and respective requestors, in some examples, the component 210a is a chip unit or “unit” which includes a multitude of associated requestors. In this example, each requestor has a respective FHA controller such that there is a plurality of requestors and FHA controllers in each unit or component 210a.

In some examples, each corresponding components 210 on each chip and drawer in the system 100 also includes a FHA controller similar to the controllers 350 and 351a-e. FIG. 3 also includes a resource request, such as the request 315. In this example, the requestor 310a requests access to a resource “X”, such as the resource 320a via the component 210a and the controller 350. While shown as a request from the requestor 310a, the request may also come from the component 210a itself. For example, the component 210a as a requestor, requests access to the resource 320a. While shown as a local request (i.e. on the chip 120a) in FIG. 3, the request 315 may include a request external to the chip 120a, such as a request for a resource on one of the chips 120b-120n or a resource on one of the drawers 110b-110n.

Returning back to FIG. 1, the resources, requestors, and various other electronic components are arranged in a various subsystems of the system 100 down to a computing components level (e.g., requestors/resources, etc.). For example, the system 100 includes an arrangement of first subsystems such as drawers 110a-110b, and each of the drawers 110a-110a includes an arrangement of subsystems such as individual chips. For example, the drawer 110a includes chips 120a-120n. For ease of illustration, the chips 120a-120n are only discussed in relation to the drawer 110a; however, each of the drawers 110b-n also includes corresponding chips similar to the chips 120a-120n. Additionally, the chips 120a-120n (as well as the chips on the drawers 110b-n) include an arrangement of subsystems, such as requestors/resources and other components (e.g., components 210, etc.). While shown in the various Figs. as a system with drawers, chips, etc., the system 100 may include any computing system with a hierarchal arrangement of computing components, systems, and subsystems.

As noted above, a flat and static FHQ topology (or other non-scope based hang avoidance) implemented in the system 100 may lead to a very high frequency of system wide FHQ events. For example, in an FHQ implementation, a hang or potential hang in the drawer 110c results in a FHQ request to stop new requests across the system 100, including in the drawers 110a, 110b, and 110n. While in some examples, this system wide request stoppage may be required to avoid the hang in the drawer 110c, a more focused hang avoidance mechanism with a limited scope (e.g., request stop on the drawer 110c) may also resolve the potential hang. Additionally, frequent FHQ events across an entire system, such as the system 100, may in turn cause overall performance impact across all participants in the system (e.g., among all of the systems and subsystems in the system 100) to resolve specific, locally contained resource access issues.

To provide the scope based FHA mechanism described herein, the system 100 includes FHA controllers, such as the controllers 350 and 351a-351n implemented in the system 100. The FHA controllers provide scope specific hang avoidance activation as well as flexibility in what actions to take as part of a hang avoidance implementation and which hang avoidance mechanisms to enact when an FHA condition is detected. The various FHA controllers are interconnected or otherwise in communication with each other using an on-chip and off-chip FHA network, network 150, which propagates FHA information, such as FHA activation and deactivation requests within and across the various subsystems of the system 100. For example, an FHA controller on the chip 120a may detect a hang condition for a requestor on the chip 120a and first activate FHA at unit level and then proceed to escalate FHA to a next hierarchal level/FHA scope via the network 150 as described in more detail in relation to FIG. 4.

The various scopes of FHA activation are shown in FIG. 4 which illustrates activation scopes for hang avoidance mechanisms, according to one embodiment. For example, an FHA controller, such as the controller 350, begins in an idle state at a scope 410 where no hang or potential hangs are detected. For example, resource request from requestors associated with the controller 350, including the request 315, are provided access to resources without significant delay such that the resource request does not cause hangs or large impacts on system performance. In the scope 410, no FHA mechanisms are active on the controller 350, for the request 315, and no FHA requests are sent to other FHA controllers in the system 100.

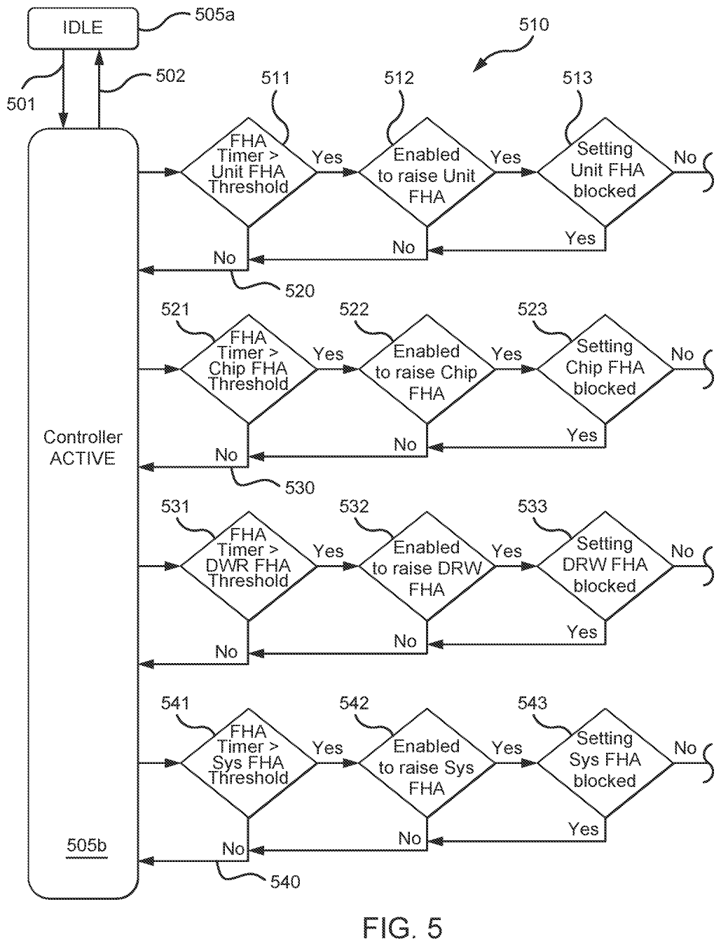

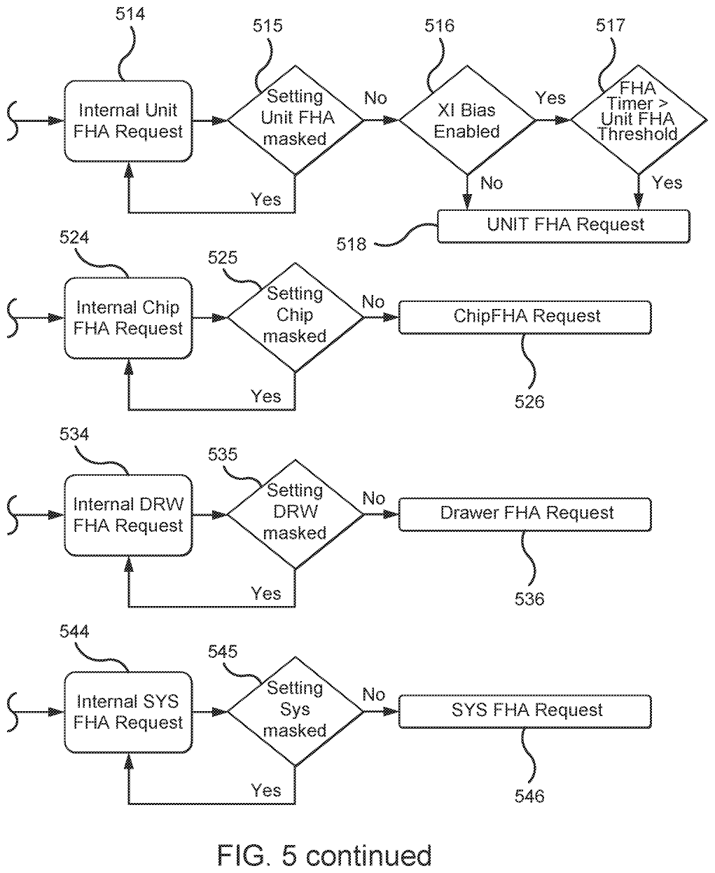

In an example where the controller 350 detects FHA conditions exceed a threshold for FHA activation, the controller 350 begins proceeding through scopes 420-450 in order to provide FHA for a pending resource request. The various methods activating FHA mechanism and responding to FHA requests in the scopes 420-450 are discussed in more detail in relation to FIGS. 5-8. In the scope 420, FHA mechanisms are activated on a limited or unit level scope. For example, Unit FHA in the scope 420 may only activate FHA mechanisms for a specific requestor. For example, the controller 350 causes the requestor 310a to stop sending new resource requests or blocks new requests from the requestor 310a while under FHA activation in the scope 420. In some examples, FHA mechanisms in the scope 420 relieves the FHA conditions detected by the controller 350 (e.g., a request 315 is granted access to the resource) without impacting other resources and requestors unrelated to the processing conditions that are causing the FHA condition. That is in the scope 420, the controller 350 is able to provide FHA mechanisms and possible resolution to the FHA conditions without impacting devices outside of the unit level scope of the scope 420. For example, none of the other requestors on the chip 120a are affected by the activation of the FHA mechanisms in the scope 420 at the controller 350.

In another example, active FHA mechanisms in the scope 420 may not resolve the FHA conditions. For example, the request 315 is still pending and requesting access to the resource 320a at a subsequent or later time and while in the scope 420. In order to resolve the FHA condition, the controller 350 raises a scope of the active FHA mechanisms. In the scope 430, FHA mechanisms are activated on a less limited basis compared to the scope 420. For example, the controller 350 activates Chip FHA mechanisms on a chip level scope. For example, the controller 350 causes the requestors 310a-n (i.e. all requestors on the chip 120a) to stop sending new resource requests. In some examples, FHA mechanisms in the scope 430 relieves the FHA conditions for the request 315 detected by the controller 350. In the scope 430, the controller 350 provides FHA mechanisms and possible resolution to the FHA conditions without impacting devices outside of the chip level scope of the scope 430. For example, none of the other requestors on the chips 120b-n are affected by the activation of the FHA mechanisms in the scope 430 at the controller 350.

In another example, active FHA mechanisms in the scope 430 may not resolve the FHA conditions. For example, the request 315 is still pending and requesting access to the resource 320a at a third time. In order to resolve the FHA condition the controller 350 raises a scope of the FHA mechanisms to scope 440 and then to scope 450 as needed. In the scope 440, FHA mechanisms are activated on a more general basis compared to the scopes 420 and 430. For example, the controller 350 activates Drawer FHA mechanisms on a drawer level scope in the scope 440 and System FHA mechanisms in a system level scope in the scope 450. For example, in the scope 440, the controller 350 causes the requestors on every chip 120a-120n on the drawer 110a to stop sending new resource requests. In some examples, FHA mechanisms in the scope 440 relieves the FHA conditions for the request 315 detected by the controller 350 without impacting devices outside of the drawer level scope of the scope 430. For example, none of the other requestors on the drawers 110b-n are affected by the activation of the FHA mechanisms in the scope 440 at the controller 350.

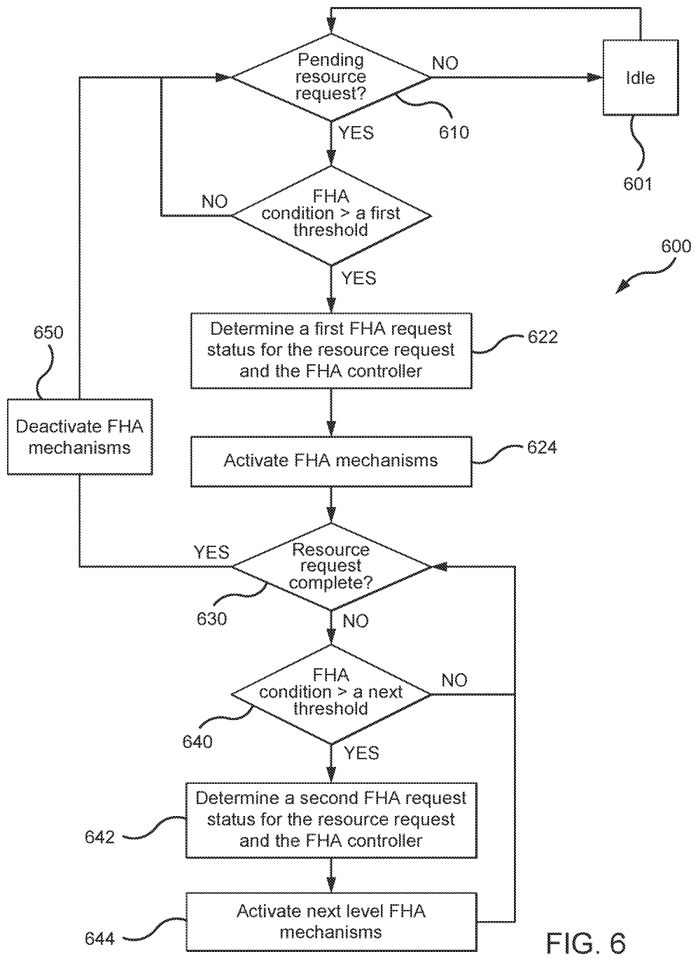

In an example, where the FHA condition persists, the controller 350 may raise the scope of the FHA activation to activate the System FHA mechanisms, where every requestor in the system 100 is subject to FHA activation. For example, in the scope 450, the controller 350 causes every requestor in the system 100 to stop sending new resource requests until resolution of the FHA condition. While shown as five scopes in FIG. 4, the number of scopes for FHA activation may include any number of appropriate scopes for the system, where each scope includes a defined set of components, subsystems, and/or systems included in the scope. The scopes of FIG. 4 provide for resolution of resource conflicts within a scope without any impact to requestors outside each specific scope. Additionally, the FHA controllers described herein provide more configurability in the activation of the FHA mechanisms in each scope as described in relation to FIGS. 5 and 6.

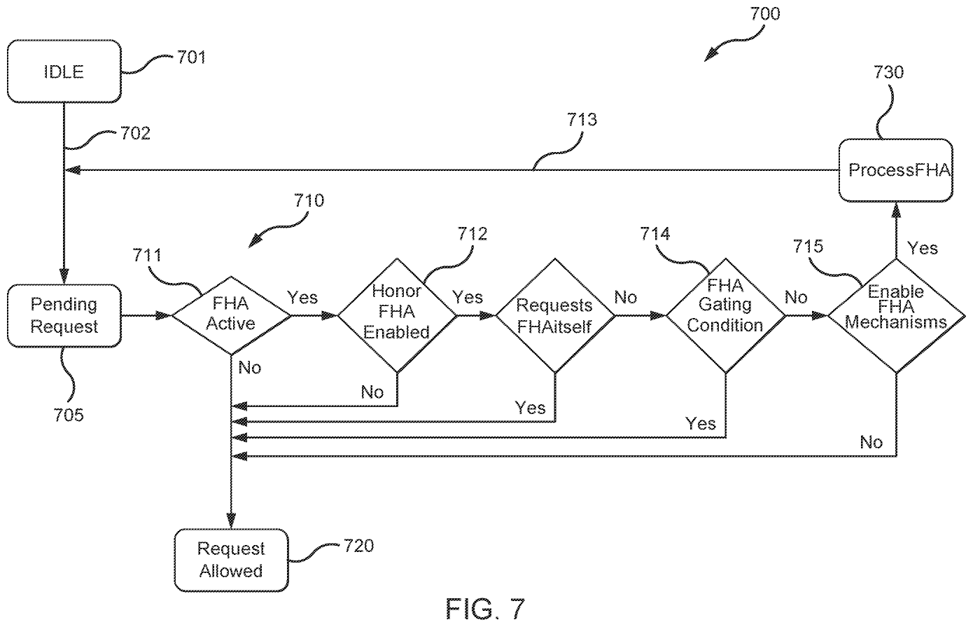

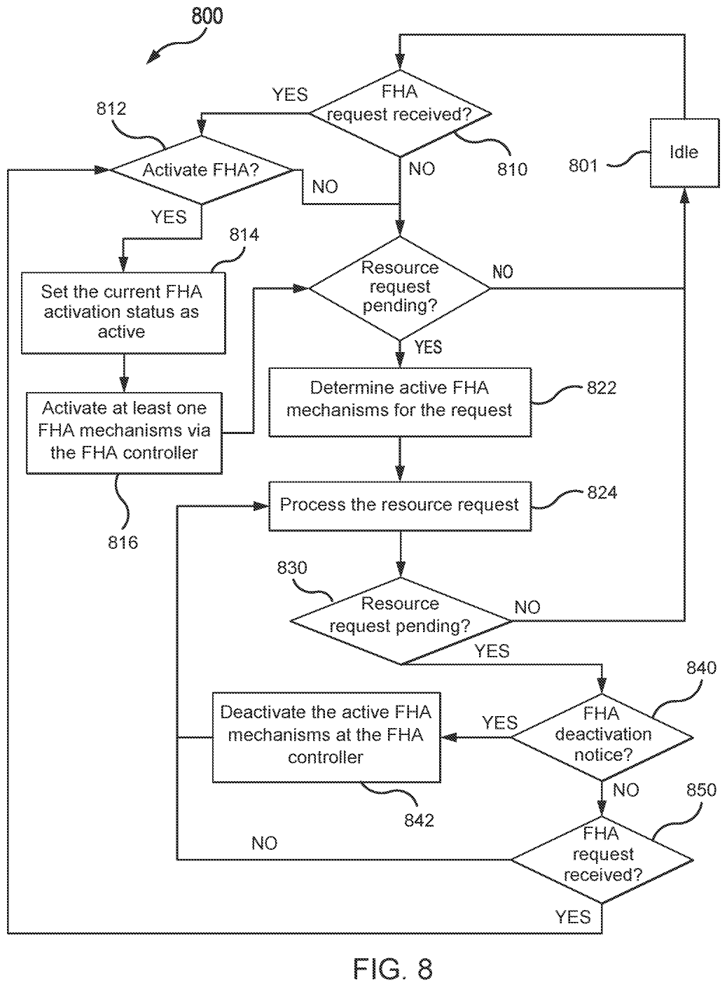

FIG. 5 illustrates a state machine for activating scope based hang avoidance and FIG. 6 illustrates a method for activating scope based hang avoidance, according to embodiments described herein. The implementation of hang avoidance mechanisms at FHA controllers is discussed in relation to FIGS. 7-8 below. For case of discussion, reference is made to the steps of flow 500 of FIG. 5 in relation to the blocks of method 600 of FIG. 6. Additionally, reference is made to FIGS. 1-4 and system 100 throughout the discussion of FIGS. 5 and 6. While discussed in relation to system 100 and flow 500, method 600 may be performed by any hang avoidance device or FHA controller in any computing system, including distributed and SMP systems.

Method 600 begins at block 601 where a hang avoidance controller, such as controller 350 enters an IDLE or waiting state for activating FHA mechanisms. For example, as shown in flow 500, the controller 350 is in IDLE state 505a. In some examples, the IDLE state 505a is limited for a specific process. For example, the controller 350 may be in an idle state for one requestor/request/resource and non-idle or active for a different resource request. For example, with reference to FIG. 3, the controller 350 may be in an IDLE state for the requestor 310a, where there are no pending requests from the requestor 310a, but the controller 350 may be in an active state for a different requestor (e.g. a request for resources is received from a different requestor under the controller of the controller 350).

At block 610, the controller 350, determines whether a resource request is pending at the controller 350. For example, at step 501 a resource request, such as request 315, is received from a requestor, such as the requestor 310a and the controller 350 enters a controller active state, ACTIVE state 505b. In some examples, upon entering the ACTIVE state 505b, the controller 350 initiates a tracking metric for FHA conditions. For example, the requestor 310a may request a resource X (i.e., resource 320a) in the request 315 and the controller 350 begins tracking whether the request 315 for the resource X has been completed. In some examples, the controller 350 tracking metric for FHA conditions is a pending time for a resource request tracked by an FHA timer. For example, the controller 350 begins tracking a time passed since receiving the request 315 at the controller 350 and method 600 proceeds to block 620.

In some examples at block 610, the controller determines that there are no pending resource requests. For example, when the request 315 accesses the resource X or otherwise completes, the controller 350 resets the tracking metric or tracked time (e.g., the FHA timer) for the request 315 and returns to an IDLE or waiting state. For example, at block 610, when the pending resource request is completed (e.g., the request 315 has gained access the resources X or otherwise completed), method 600 returns back to block 601. As shown in FIG. 5, the controller 350, in the ACTIVE state 505b returns to IDLE state 505a at step 502. In another example, no pending requests are outstanding at the controller 350 and no resource request has been received by the controller 350, method 600 returns to block 601 to the IDLE or waiting state to await a resource request from requestors.

As described above when a pending resource request is detected at the controller 350, the controller tracks the time passed since receiving the request 315 at the controller 350 (or other appropriate tracking metric) and method 600 proceeds to block 620. At block 620 the controller 350 determines when an FHA condition for a resource request exceeds a first threshold for FHA activation. For example, the controller 350 detects, at first time, the FHA condition (i.e., the FHA timer) exceeds a first threshold (e.g., a time threshold) for FHA activation. In some examples, the FHA condition is an independent timeout value that is specified per controller type. For example, an FHA controller associated with a requestor type may include a first timeout value and a different FHA controller associated with a different type of requestor may include a second timeout value different from the first timeout value. In this example, the time a request for a resource waits before FHA activation is different based on the type of request, requestor, and FHA controller. In an example where the FHA condition is above the threshold for the controller 305, method 600 proceeds to block 622.

In another example, the controller 350 determines that the FHA condition (e.g., the tracking metric or FHA timer) is not above the first threshold for FHA activation and method 600 returns to block 610. In the example where the request 315 is received by the controller 350 and accesses the resource X without the controller 350 detecting any FHA condition in any tracking metric, the requestor 310a is able to access the requested resource X in a timely manner without resource starvation or causing deadlocks or system hangs in the system 100. In this example, method 600 proceeds from block 601 to block 610 and 620 and back to block 610 and 601 without FHA activation on any scope. In the flow 500, the controller enters ACTIVE state 505b at step 501 and returns to IDLE state 505a at step 502 without entering any FHA states as described in more detail herein.

Returning back to block 620, as noted above, in some examples, the controller 350 detects, at a first time, the FHA condition (i.e., the tracking metric or FHA timer) exceeds a first threshold for FHA activation. In some examples, the first threshold is a first waiting time that the resource request has passed. For example, the requestor 310a has a pending resource request, such as the request 315, and the request has remained pending for a given period of time as tracked by the controller 350. In an example where the given period of time matches or exceeds a threshold for activating FHA on at least one FHA controller in a first system (e.g., scope 420) scope of a plurality of system scopes (e.g., scopes 420-450), the method 600 proceeds to block 622. For example, the controller 350 includes a Unit FHA threshold, Chip FHA threshold, Drawer (DWR) FHA threshold, and System (SYS) FHA threshold, corresponding to the scopes 420-450.

With reference to FIG. 5, the controller 350 first proceeds through stage 510 which includes steps 511-513 and 515-517. The controller 350 at step 511 determines when a FHA condition, such as the FHA timer for the request 315 has surpassed a Unit FHA threshold. For example, the FHA timer may pass a given time defined to indicate a Unit FHA scope, such as scope 420 is needed, to prevent hangs in the system 100. In an example, where the timer is not above the unit FHA threshold, the controller 350 remains in the ACTIVE state 505b at step 511. In some examples and as described above, some requestors, controllers, and resource types may reach a threshold for a given FHA scope, but various properties and settings at the controller 350 may alter or prevent enabling FHA within the FHA scope based on an FHA request status as determined in block 622 of FIG. 6.

At block 622, the controller 350 determines a first FHA request status for the resource request and the FHA controller. In some examples, the controller 350 utilizes activation settings for the controller 350, a requestor type for the resource request, such as the request type for the requestor 310a, and the relevant system scope to determine the FHA request status. In some examples, the FHA request status indicates whether the controller 350 is capable of activating FHA mechanisms across multiple other FHA controllers and system components (e.g., the controller 350 is able to send a request to FHA controllers or other components to implement FHA). In some examples, the controller 350 determines the FHA request status in several steps as described in relation to steps 512-513 and steps 515-517 in FIG. 5.

For example, at step 512, the controller 350 determines a capability of the FHA controller to enable FHA activation within first system scope. The controller 350 using activation settings and other information for the controller 350, determines whether the controller 350 is enabled to raise FHA within the given scope, (e.g., unit FHA scope, scope 420). For example, an FHA controller may be limited in activating Unit FHA mechanisms by controller type (e.g., device type) and a current state of the controller or system. For example, an I/O FHA controller asked to suspend progress (e.g., due to an I/O hold) may be prevented from sending an FHA request to activate FHA mechanisms on any scope in the system even if waiting for longer than an FHA threshold.

In an example where the controller is not enabled to raise Unit FHA, the controller remains in the ACTIVE state 505b. In an example where the controller 350 is enabled to raise Unit FHA, the controller 350 moves to step 513 and determines, based on a current state of the FHA controller and a general system state, a blocking condition for enabling FHA activation. For example, the controller 350 determines from various settings on the controller and from a system status of the system 100 (including statuses of the various subsystems) whether setting or raising Unit FHA is blocked at the first time. For example, a controller 350 may be enabled to activate FHA within a given scope, but may be blocked at given time based on the controller type or a system setting. For example, a requestor holding on to a resource, such as requestor 310b holding access to resource 320a, for responsiveness/forward progress reasons of the system overall, may signal this state to the controller 350, the controller 350, in turn, does not request FHA even when the request 315 is waiting for longer than an FHA threshold.

The various FHA controllers may also include additional mechanisms for determining when to active FHA mechanisms, such as a secondary timeout value. In this example, the FHA controller implementing a timeout prevents frequent FHA requests such that a “greedy” requestor (e.g., the requestor 310a) cannot completely lock out other requestors by frequently causing FHA activation. These mechanisms prevent FHA controllers from activating FHA and slowing down the various subsystems and the system 100 overall due to FHA activation. In some examples, these requests may also include requests where activating FHA would not address the FHA conditions observed by the FHA controller. In each of these examples, where FHA activation is blocked, the controller remains in the ACTIVE state 505b.

In an example where raising Unit FHA is not blocked the first FHA request status is an enabled activation status when the capability of the FHA controller and the blocking condition both indicate FHA activation is allowed for the FHA condition at the first FHA controller. The controller 350 then enters into an internal request state 514 where the controller 350 is in the Unit FHA scope, scope 420, internally. For example, the controller 350 generates an internal FHA request prior to activating FHA mechanisms on other controllers or components. In some examples, the internal request state 514 allows for the controller 350 to enact FHA mechanisms at the controller 350 before verifying that other FHA controllers within the given scope (e.g., the scope 420) are to be activated.

In some examples, the controller 350 performs additional checks/verifications before raising FHA at other FHA controllers. For example, the controller 350 detecting, based on a current state of the FHA controller and a general system state, FHA activation for the first FHA controller is masked. When the FHA activation is masked activating FHA mechanisms includes activating the internal FHA request on the first FHA controller at the internal request state 514 and suppressing activation at one or more other FHA controllers in the first system scope. For example, the controller 350 does not transmit an FHA request to other components in the network 150. In another example, when the activation is not masked the controller checks a bias at step 516 and verifies the FHA timer remains above the unit FHA threshold prior to FHA activation.

At block 624, the controller 350 activates, based on the first FHA request status, FHA mechanisms on the at least one FHA controller within the first system scope. In some examples, the controller 350 activates FHA mechanisms by transmitting an FHA request to the at least one FHA controller in the first system scope. In some examples, the controller 350 propagates an assertion and de-assertion of the various FHA activation states and scope via on-chip interfaces (e.g., a central ring on chip) as well as via off-chip interfaces (e.g., special service packets). For example, the controller 350 communicates with on-chip components, components 210, via a central ring and with the chips 120b-n and drawers 110b-n via special service packets. Referring back to FIG. 5. At step 518 the controller 350 generates and transmits a UNIT FHA request (via the central ring, special service packet, etc.).

While the steps of blocks 620-624 are described in relation to stage 510 of FIG. 5, similar steps are performed for each FHA scope, such as the scopes 430-450, in the stages 520, 530, and 540. In some examples, at the step 518, once the Unit FHA mechanisms are activated via the unit FHA request, the controller 350 in the ACTIVE state 505b continues monitoring the FHA condition, such as the FHA timer, to determine when a next level scope is needed to avoid hangs in the system 100. The controller 350 also monitors for completion of the associated resource request.

For example, at block 630, the controller 350 determines whether the pending resource request is complete (i.e. still pending or waiting for access to the requested resource). In an example where the request 315 is complete, method 600 proceeds to block 650 to deactivate any active FHA mechanisms. In some examples, the completion of the request 315 triggers the controller 350 to move from the ACTIVE state 505b to the IDLE state 505a even when proceeding through any of the stages 510-540. For example, when the controller 350 determines that the request 315 has accessed the requested resource while step 516 is underway causes the controller 350 to stop the current step of the flow 500 and move to the IDLE state 505a.

Returning back to FIG. 6, in an example where the request 315 is not complete, method 600 proceeds to block 640 to continue monitoring FHA conditions and escalates the scope of FHA mechanisms as needed. At block 640, the controller 350 detects, at a second time or next time after the first time at block 620, the FHA condition for the resource request exceeds a next or second threshold for FHA activation on a plurality of FHA components in a second system scope of the plurality of system scopes. For example, at a second time, the FHA timer may exceed a second threshold, such as a Chip FHA threshold at step 521 for activating a chip level FHA scope, such as the scope 430. For example, the FHA timer may pass a given time defined to indicate a chip FHA scope, such as scope 430 is needed, to prevent hangs in the system 100. In an example, where the timer is not above the unit FHA threshold, the controller 350 remains in the ACTIVE state 505b at step 531. In some examples and as described above, some requestors, controllers, and resource types may reach a threshold for a given FHA scope, the chip FHA scope, but various properties and settings at the controller 350 may alter or prevent enabling FHA within the FHA scope based on an FHA request status as determined in block 642 of FIG. 6.

At block 642, the controller 350 determines, based on the activation settings for the FHA controller and the second system scope, a second FHA request status for the resource request and the FHA controller. In some examples, the controller 350 utilizes activation settings for the controller 350, a requestor type for the resource request, such as the request type for the requestor 310a, and the relevant system scope (e.g., chip, drawer, system, etc.) to determine the FHA request status. In some examples, the FHA request status indicates whether the controller 350 is capable of activating FHA mechanisms across multiple other FHA controllers and system components (e.g., the controller 350 is able to send a request to FHA controllers or other components to implement FHA). In some examples, the controller 350 determines the FHA request status in several steps as described in relation to steps 521-523, 525, 531-533, 535, 541-543, and 545 in FIG. 5. In some examples, the steps in the stages 520, 530, and 540 are similar to the corresponding steps in the stage 510 (including internal request states 524, 534, 544), where the controller 350 applies respective scope level rules and determinations based on scope setting and system status.

At block 644, the controller 350 activates, based on the second FHA request status, FHA mechanisms on the plurality of FHA controllers in the second system scope. For example, at steps 526, 536, and 546, the controller 350 communicates with on-chip components, components 210, via a central ring and with the chips 120b-n and drawers 110b-n via special service packets to communicate the activation of the various FHA scopes. The steps of block 630-644 continue for as long as the controller 350 remains in the ACTIVE state 505b and the FHA condition, such as the FHA timer, continues tracking the request 315. As described above, whenever the request 315 accesses the requested resource (or otherwise enters a valid or completed state), the controller 350 moves from the ACTIVE state 505b to the IDLE state 505a and the controller 350 deactivates any active FHA mechanisms for the request 315.

For example, at block 630, the controller 350 detects a completion of the resource request at the FHA controller and at block 650, the controller 350 deactivates the FHA mechanisms on the at least one FHA component within the first system scope and any other FHA components in the various other scopes. For example, the controller 350 communicates with on-chip components, components 210, via a central ring and with the chips 120b-n and drawers 110b-n via special service packets to communicate a deactivation notice of the various FHA scopes for the request 315. In any of the examples above, the specified scopes and as well as the activation settings described in the steps of the stage 510-540 provide high configurability for FHA activation and provide for the system 100 to provide FHA on a scope level which enable resolution of resource conflicts within a scope without any impact to requestors outside each specific scope. While the activation processes described in FIGS. 5-6 provide the configurability and scope level activation, the various FHA controllers also provide configurability on the implementation of the FHA mechanisms as described in relation to FIGS. 7-8.

FIG. 7 illustrates a state machine for implementing scope based hang avoidance, according to embodiments described herein. FIG. 8 illustrates a method for implementing scope based hang avoidance, according to embodiments described herein. For ease of discussion, reference is made to the steps of flow 700 of FIG. 7 in relation to the blocks of method 800 of FIG. 8. Additionally, reference is made to FIGS. 1-4 and system 100 throughout the discussion of FIGS. 7 and 8. While discussed in relation to system 100, flow 700 and method 800 may be performed by any hang avoidance device in any computing system, including distributed and SMP systems.

Method 800 begins at block 801 where a hang avoidance controller, such as controller 350 enters an IDLE or waiting state for implementing FHA mechanisms. For example, as shown in flow 700, the controller 350 is in IDLE state 701. In some examples, the IDLE state 701 is limited for a specific process. For example, the controller 350 may be in an idle state for one requestor/request/resource and non-idle or active for a different process. For example, with reference to FIG. 3, the controller 350 may be in an IDLE state for the requestor 310a, where there are no pending requests from the requestor 310a, but the controller 350 may be in an active state for a different requestor (e.g. a request for resources is received from a different requestor under the control of the controller 350). In another example, each requestor has an independent FHA controller, where the controller 350 is only associated with a single requestor.

At block 810, the controller 350 determines whether an FHA request is received at the controller 350. In some examples, the controller 350 receives, an FHA request internally (e.g., at one of the states 514, 524, 534, or 544) or from at least one external FHA controller, such as controller 351a. In some examples, the controller 350 may receive any of the requests generated in relation to FIGS. 5-6 from one or more other FHA controllers in the system 100 via ring communication or special service packet, etc. In an example where an FHA request is received, method 800 proceeds to block 812-816.

At block 812, the controller 350 determines an applicability of the FHA request to the FHA controller. For example, based on various activation settings on the controller 350 and the status of the system 100, the controller 350 may determine that the controller 350 is not obligated to activate FHA mechanisms for the FHA request. In some examples, the controller 350 sets a current FHA activation status as active based on the applicability of the FHA request when determined as applicable at block 812 and activates at least one FHA mechanism via the FHA controller according to the FHA request. In some examples, the controller 350 the activated FHA mechanisms including any combination of blocking, at the FHA controller, new requests from an associated resource requestor, altering a handling of the new requests at the FHA controller using one or more controller hang avoidance mechanisms, and altering handling of the new requests or pending requests at the resource. In some examples, the resource, such as the resource 320a, processes the new requests according to one or more resource provider hang avoidance mechanisms when given FHA mechanisms are active.

Returning back to block 810, when a FHA request is not received in the current iteration of the method 800, the method continues to block 820. Similarly, at block 812, when the FHA request is determined to not be applicable to the current FHA controller, e.g. controller 350, the method 800 proceeds to block 820.

At block 820, the controller 350, determines whether a resource request is pending at the controller 350. For example, at step 702 a resource request, such as request 315, is received from a requestor, such as the requestor 310a and the controller 350 enters pending request state 705. (In some examples, the receipt of the request 315 also triggers ACTIVE state 505b described above). In an example where a resource request is not received in the current iteration of the method 800, the method proceeds back to block 801 to await resource requests (e.g., the controller 350 remains in the IDLE state 701). In some examples, the controller 350 is in the IDLE state 701 and returns to block 801 with FHA mechanisms active (e.g., activated at blocks 812-814). In this example, additional FHA requests may be received and activated at blocks 810-816 before a resource request is received. Additionally, a resource request may be received by the controller at block 820 without activation of FHA mechanisms (e.g., method 800 proceeds directly from the block 801 to block 810 to block 820).

In an example where a resource request, such as request 315 is received at block 820, method 800 proceeds to block 822 where the controller 350 detects a current FHA activation status and determines active FHA mechanisms for the request. In some examples, the controller 350 determines the active FHA mechanisms based on a request type for the request, FHA settings at the FHA controller, and the current FHA activation status. In some examples, the controller 350 implements the configurable FHA implementation via steps in stage 710 of FIG. 7. For example, at step 711, the controller 350 detects from the activation status, a current FHA activation status. For example, FHA is active at the controller according to the state activated at block 814. In some examples, at step 711, FHA is not active for any scope and the controller 350 processes the request 315 with standard procedures (e.g., no delay, holding, block, etc.) at step 720.

At steps 712-715, the controller 350 determines, from FHA settings at the FHA controller and the resource request, an FHA override setting. In some examples, the controller 350 processes the resource request without implementing FHA mechanisms when the FHA override setting(s) indicate an FHA override for the resource request. For example, at step 712 the controller 350 determines based on various settings at the controller 350 whether to honor the active FHA mechanisms. For example, based on the resource request type, etc. the controller 350 determines that when the request 315 or the controller 350 is to honor the active FHA mechanisms.

At step 713, the controller 350 determines whether the current FHA mechanisms are active due to the controller 350 and the request 315. In an example, where FHA is active for the request 315 (e.g., as determined in method 600 and flow 500), the controller 350 processes the request 315 at step 720. At step 714, the controller 350 determines whether a gating condition has been met for the request 315. In some examples, the resource request, such as the request 315 includes a level of coherency. When the first level of coherency is greater than a gating threshold for the resource request and the FHA controller overrides the active FHA mechanisms to allow the request to pass to the resource at step 720.

For example, when the request 315 is nearing completion and/or has a level of processing coherency, the controller 350 processes the request 315 at step 720 despite the FHA activation status to prevent locking other resources utilized by the request 315. At step 715, the controller 350 determines which FHA mechanisms are active and proceeds to step 730 where the request 315 is processed according to the active FHA mechanisms. In some examples, active FHA mechanism include blocking, at the FHA controller, new requests from resource requestors (including the request 315), altering a handling of the new requests (including the request 315) at the FHA controller using one or more controller hang avoidance mechanisms, and altering handling of the new requests or pending requests at the resource. In some examples, when no FHA mechanisms are active against the request 315, the controller 350 processes or otherwise allows the request 315 to access the resource at step 720.

Returning back to FIG. 8, the controller 350 determines the active/applicable FHA mechanisms for the request 315 at block 822 and processes the request according to the active/applicable FHA mechanisms at block 824. In some examples, processing the request 315 includes providing the request to the requested resource (e.g., resource 320a) with no alteration or delay (e.g., when no FHA is active or when active mechanisms are not applicable). In some examples, processing the request includes waiting for the FHA resolution at step 730 and iteratively proceeding through stage 710 according to the FHA active state and various behaviors.

In some examples, as the system 100 state changes, the controller 350 state changes, or other changes occur in the system, the controller 350 may proceed through the steps of stage 710 differently. For example, in a first iteration, the request 315 may not be requesting FHA activation at 713, but may have FHA enabled (according to the method 600) at a subsequent iteration, such that processing the request 315 changes (e.g., the controller 350 provides the request to the requested resource at step 720).

At block 830, the controller 350 determines when the request 315 remains pending. For example, at step 730 in FIG. 7 the controller returns to pending request state 705 and monitors the pending request, request 315. In an example, where the request is not pending (e.g., proceeded at step 720), method 800 returns to block 801 and IDLE state 701. In an example where the request 315 remains pending at the controller 350 (e.g., the request 315 has not been processed) method 800 proceeds to block 840.

At block 840, the controller 350 whether a FHA deactivation notice is received at the controller 350. For example, the controller may receive, from an external FHA controller, an FHA deactivation notice corresponding to active FHA mechanisms at the FHA controller. In the example where the FHA deactivation notice is received by the controller 350, method 800 proceeds to block 842 where the controller 350 deactivates the active FHA mechanisms at the FHA controller (e.g., set the FHA active state to deactivate) and passes new and pending resource requests at the FHA controller to corresponding requested resources. For example, at step 711 for various resource requests the controller 350 proceeds to step 720 and passes the requests to the requested resources.

In another example, at block 850, the controller 350 determines whether another FHA request is received. For example, a FHA request of an increased scope (e.g., unit FHA scope vs chip FHA scope) is received at the controller 350. In an example where a subsequent FHA request is received, method 800 returns to blocks 812 to 816 to activate or update the current FHA activation status according to the subsequent FHA request. The controller 350 utilizes the updated FHA activation status during stage 710 and further processing of the request 315 and other new requests at block 820-824.

In an example where a subsequent FHA request is not received, method 800 returns to block 824 to continue processing of the request 315 and other new resource requests according to a current state and settings. The method 800 and use of the various FHA activation states and settings provides for highly configurable resolution of resource conflicts within a limited scope without any impact to requestors outside each specific scope.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

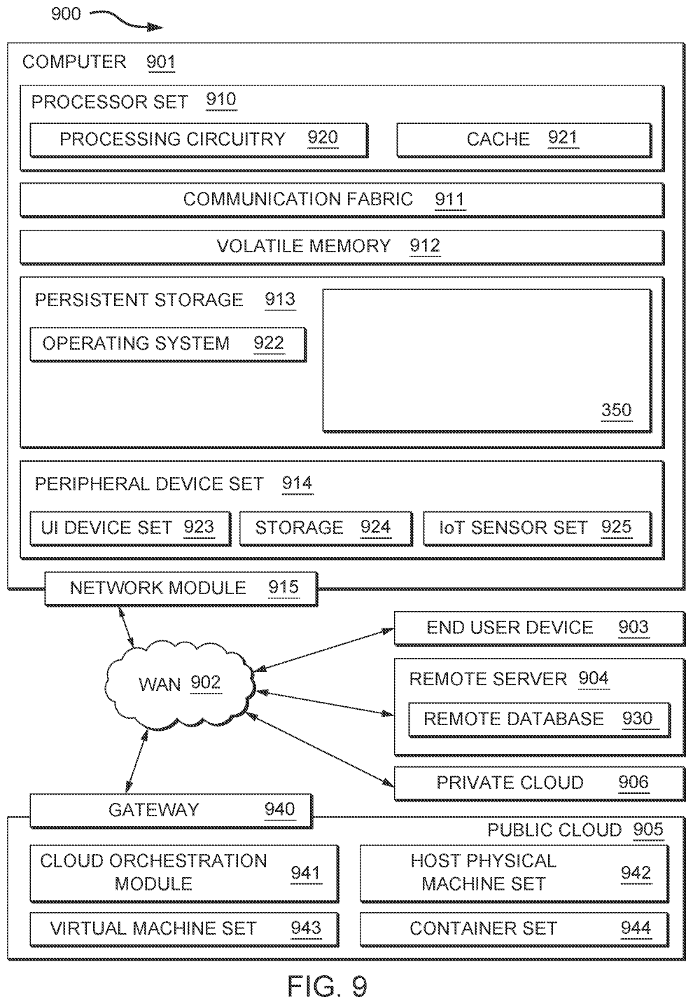

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored. FIG. 9 illustrates a block diagram of a system, according to one embodiment. Computing environment 900 contains an example of an environment for the execution of at least some of the computer code involved in performing the inventive methods, such as the methods 600 and 800 described in relation to FIGS. 6 and 8 in 950. In addition to block 950, Computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI) device set 923, storage 924, and Internet of Things (IOT) sensor set 925), and network module 915. Remote server 904 includes remote database 930. Public cloud 905 includes gateway 940, cloud orchestration module 941, host physical machine set 942, virtual machine set 943, and container sct 944.

COMPUTER 901 may take the form of a desktop computer, laptop computer, tablet computer, smart phone, smart watch or other wearable computer, mainframe computer. quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 950 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile.

In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way. EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

What is claimed is:

1. A method comprising:
detecting, at a first time and at a fast hang avoidance (FHA) controller, that an FHA condition for a resource request exceeds a first threshold for FHA activation on at least one FHA component in a first system scope of a plurality of system scopes;
determining a first FHA request status for the resource request and the FHA controller based on activation settings for the FHA controller, a requestor type for the resource request, and the first system scope; and
activating, based on the first FHA request status, FHA mechanisms on the at least one FHA component within the first system scope.

2. The method of claim 1, further comprising:
detecting, at a second time, the FHA condition for the resource request exceeds a second threshold for FHA activation on a plurality of FHA components in a second system scope of the plurality of system scopes;
determining a second FHA request status for the resource request and the FHA controller based on the activation settings for the FHA controller and the second system scope; and
activating, based on the second FHA request status, FHA mechanisms on the plurality of FHA components in the second system scope.

3. The method of claim 1, wherein activating the FHA mechanisms on the at least one FHA component in the first system scope comprises:
transmitting an FHA request to the at least one FHA component in the first system scope.

4. The method of claim 1, wherein determining the first FHA request status comprises:
determining a capability of the FHA controller to enable FHA activation within first system scope; and
determining, based on a current state of the FHA controller and a general system state, a blocking condition for enabling FHA activation, wherein the first FHA request status comprises an enabled activation status when the capability of the FHA controller and the blocking condition both indicate FHA activation is allowed for the FHA condition at the FHA controller.

5. The method of claim 1, further comprising:
generating an internal FHA request at the FHA controller prior to activating FHA mechanisms;
detecting, based on a current state of the FHA controller and a general system state, that an FHA activation for the FHA controller is masked; and
wherein activating FHA mechanisms comprises:
activating the internal FHA request on the FHA controller; and
suppressing activation at one or more other FHA components in the first system scope.

6. The method of claim 1, wherein the FHA condition comprises a pending time for a resource request, and wherein the first threshold for FHA activation comprises a time threshold for the first system scope.

7. The method of claim 1, further comprising:
detecting a completion of the resource request at the FHA controller; and
deactivating the FHA mechanisms on the at least one FHA component within the first system scope.

8. A system comprising:
processor; and
a memory containing a program which when executed by the processor performs an operation comprising:
detecting, at a first time and at a fast hang avoidance (FHA) controller, an FHA condition for a resource request exceeds a first threshold for FHA activation on at least one FHA component in a first system scope of a plurality of system scopes;
determining a first FHA request status for the resource request and the FHA controller based on activation settings for the FHA controller, a requestor type for the resource request, and the first system scope; and
activating, based on the first FHA request status, FHA mechanisms on the at least one FHA component within the first system scope.

9. The system of claim 8, wherein the operation further comprises:
detecting, at a second time, the FHA condition for the resource request exceeds a second threshold for FHA activation on a plurality of FHA components in a second system scope of the plurality of system scopes;
determining a second FHA request status for the resource request and the FHA controller based on the activation settings for the FHA controller and the second system scope; and
activating, based on the second FHA request status, FHA mechanisms on the plurality of FHA components in the second system scope.

10. The system of claim 8, wherein activating the FHA mechanisms on the at least one FHA component in the first system scope comprises:
transmitting an FHA request to the at least one FHA component in the first system scope.

11. The system of claim 8, wherein determining the first FHA request status comprises:
determining a capability of the FHA controller to enable FHA activation within first system scope; and
determining, based on a current state of the FHA controller and a general system state, a blocking condition for enabling FHA activation, wherein the first FHA request status comprises an enabled activation status when the capability of the FHA controller and the blocking condition both indicate FHA activation is allowed for the FHA condition at the FHA controller.

12. The system of claim 8, further comprising:
generating an internal FHA request at the first FHA controller prior to activating FHA mechanisms;
detecting, based on a current state of the FHA controller and a general system state, FHA activation for the FHA controller is masked; and
wherein activating FHA mechanisms comprises:
activating the internal FHA request on the FHA controller; and
suppressing activation at one or more other FHA components in the first system scope.

13. The system of claim 8, wherein the FHA condition comprises a pending time for a resource request, and wherein the first threshold for FHA activation comprises a time threshold for the first system scope.

14. The system of claim 8, further comprising:
detecting a completion of the resource request at the FHA controller; and
deactivating the FHA mechanisms on the at least one FHA component within the first system scope.

15. A method comprising:
receiving, at a fast hang avoidance (FHA) controller for a first level in a system, a resource request for a resource;
detecting, at the FHA controller, a current FHA activation status;
determining active FHA mechanisms for the resource request based on a request type for the resource request, FHA settings at the FHA controller, and the current FHA activation status; and
processing the resource request according to the active FHA mechanisms.

16. The method of claim 15, further comprising:
receiving an FHA request from at least one external FHA controller;
determining an applicability of the FHA request to the FHA controller; and
setting the current FHA activation status as active based on the applicability of the FHA request.

17. The method of claim 16, further comprising:
activating at least one FHA mechanisms via the FHA controller according to the FHA request wherein active FHA mechanisms comprise one or more of:
blocking, at the FHA controller, new requests from resource requestors;
altering a handling of the new requests at the FHA controller using one or more controller hang avoidance mechanisms; and
altering handling of the new requests or pending requests at the resource, wherein the resource processes the new requests according to one or more resource provider hang avoidance mechanisms.

18. The method of claim 15, wherein determining active FHA mechanisms for the resource request comprises:
determining, from FHA settings at the FHA controller and the resource request, an FHA override setting, wherein the FHA controller processes the resource request without implementing FHA mechanisms when the FHA override setting indicates an FHA override for the resource request.

19. The method of claim 18, wherein the FHA override setting comprises a gating condition for a resource request, wherein the resource request comprises a first level of coherency, wherein the first level of coherency is greater than a gating threshold for the resource request, and wherein the FHA controller overrides the active FHA mechanisms to allow the resource request to pass to the resource.

20. The method of claim 15, further comprising:
receiving, from an external FHA controller, an FHA deactivation notice corresponding to active FHA mechanisms at the FHA controller;
deactivating the active FHA mechanisms at the FHA controller; and
passing new resource requests at the FHA controller to corresponding requested resources.
